(19) United States
(12) Patent Application Publication
(10) Pub. No.: US 2023/0071484 A1
(43) Pub. Date: Mar. 9, 2023

(54) METHOD FOR FORECASTING RUNOFF UNDER INFLUENCE OF UPSTREAM RESERVOIR GROUP BY UTILIZING FORECASTING ERRORS

(71) Applicants: CHINA THREE GORGES CORPORATION, Beijing (CN); CHINA INSTITUTE OF WATER RESOURCES AND HYDROPOWER RESEARCH, Beijing (CN)

(72) Inventors: Hao WANG, Beijing (CN); Mingxiang YANG, Beijing (CN); Huichao DAI, Beijing (CN); Yunzhong JIANG, Beijing (CN); Yong ZHAO, Beijing (CN); Ningpeng DONG, Beijing (CN); Heng YANG, Beijing (CN); Yongnan ZHU, Beijing (CN); Zhaohui YANG, Beijing (CN)

(21) Appl. No.: 17/626,037

(22) PCT Filed: Mar. 15, 2021
(86) PCT No.: PCT/CN2021/080782

§ 371 Date: Jan. 10, 2022

(30) Foreign Application Priority Data
Apr. 28, 2020 (CN) 202010349743.5

(51) Int. Cl. G06Q 10/04; G06Q 10/06

(52) U.S. Cl. CPC G06Q 10/04; G06Q 10/0635

(57) ABSTRACT

Disclosed in the present invention is a method for forecasting runoff under influence of an upstream reservoir group by utilizing forecasting errors. The method comprises: collecting data; establishing a regulation and storage influence quantity estimation model by utilizing a known hydrological model and a KNN model according to the collected data; driving the hydrological model by combining the collected data to predict a future runoff volume; obtaining a forecast error in a previous time period; obtaining a future regulation and storage influence quantity estimated value according to the forecast error in the previous time period in combination with the regulation and storage influence quantity estimation model; and superposing the future runoff volume and the future regulation and storage influence quantity estimated value to obtain a runoff forecast value in a future time period.

### CROSS-REFERENCE TO RELATED APPLICATION

This Application is a national stage application of PCT/CN2021/078364. This application claims priorities from PCT Application No.PCT/CN2021/080782, filed Mar. 15, 2021, and from the Chinese patent application 202010349743.5 filed Apr. 28, 2020, the contents of which are incorporated herein in the entirety by reference

### FIELD OF TECHNOLOGY

The present invention relates to the technical field of hydrological forecast, and in particular to a method for forecasting runoff under the influence of an upstream reservoir group by utilizing forecasting errors.

### BACKGROUND

Accurate hydrological forecast is a prerequisite for flood prevention and drought relief and promotion of positive effects and scheduling, and has high economic and social values. With the continuous advancement of human science and technology, human beings have become more and more powerful in transforming nature. Building reservoirs to supply water to cities and using hydro-power resources to generate electricity is a manifestation of transforming and utilizing nature by human beings.

At present, China has more than 100,000 reservoir projects and is the country with the largest number of reservoirs in the world. A large number of reservoirs have brought convenience to China's economic development, but they have also drastically changed the hydrological laws of river basin and turned a natural runoff process into a runoff process under the influence of human activities, which brings difficulties to the hydrological forecasting. This is mainly because the reservoir project group has an ability to change the time allocation of runoff, and can store incoming water in a certain time period (incoming amount is greater than outgoing amount), or it can release in a certain time period the water stored in the reservoir (the outgoing amount is greater than the incoming amount), which breaks natural hydrological laws of precipitation, runoff producing, confluence, and river evolution, and severely reduces the accuracy of traditional regulation and storage influence quantity estimation models.

At present, the problem of low accuracy of downstream runoff forecast caused by upstream reservoir group storage and release is mainly solved by obtaining the upstream reservoir group's storage and release plan in real time and superimposing the results of an interval hydrological forecast on this basis. The application prerequisite for this method is to be able to obtain information on the storage and release plan of the upstream reservoir group, but the actual situation is that the upstream reservoir does not directly share or provide such information in most cases (due to commercial secrets, etc.), and the number of reservoir groups in upstream of a forecast section is often unusually large. As a result, in most cases, it is impossible to obtain information on the storage and release plan of the reservoir group in the upstream of the forecast section. Therefore, the influence of the upstream reservoir group causes the problem that the traditional hydrological forecast model to have a low accuracy, and the application conditions of the existing solutions are too harsh and are not practical.

### SUMMARY

The purpose of the present invention is to provide a method for forecasting runoff under the influence of an upstream reservoir group by utilizing forecasting errors, thereby solving the aforementioned problems in the prior art.

In order to achieve the above purpose, technical solutions adopted by the present invention are as follows:

A method for forecasting runoff under the influence of an upstream reservoir group by utilizing forecasting errors, wherein the method comprises the following steps:

S1, collecting data;

S2, establishing a regulation and storage influence quantity estimation model by utilizing a known hydrological model and a KNN model according to the collected data;

S3, driving the hydrological model by combining the collected data to predict a future

runoff volume;

S4, obtaining a forecast error in a previous time period;

S5, obtaining a future regulation and storage influence quantity estimated value according to the forecast error in the previous time period in combination with the regulation and storage influence quantity estimation model;

S6, superposing the future runoff volume and the future regulation and storage influence quantity estimated value to obtain a runoff forecast value in a future time period.

Preferably, the data collected in step S1 specifically comprises precipitation data and runoff data, and the precipitation data is precipitation data during a time period from the time when the upstream reservoirs begin to significantly affect a downstream runoff process to the current time; the runoff data is precipitation data during a time period from the time when the upstream reservoirs begin to significantly affect the downstream runoff process to the current time.

Preferably, step S2 specifically comprises the following contents:

S21, based on a premise that a main source of the forecast errors is a natural runoff change caused by upstream reservoir regulation and storage, obtaining a forecast error calculation formula,

ω=δ+ϵ

wherein ω is a total forecast error; δ is a forecast error caused by the upstream reservoir regulation and storage; ϵ is other forecast error; ω≈δ;

S22, generalizing a mechanism of the runoff change caused by the reservoir regulation and storage as

δᵢ=T(stateᵢ₋₁)

wherein statei−1 is a state of the reservoir at the initial moment, that is, a state of the reservoir at the end of the previous time period, and δi is a runoff forecast error at the current moment, that is, a runoff change volume caused by the reservoir regulation and storage; then the reservoir state at the current moment is calculated as

stateᵢ=stateᵢ₋₁−86400×δᵢ;

S23, establishing the regulation and storage influence quantity estimation model by utilizing the known hydrological model and the KNN model, where the regulation and storage influence quantity estimation model is a relationship between the forecast error in the current time period and the runoff change volume caused by the reservoir regulation and storage in the next time period.

Preferably, the known hydrological model is a Xinanjiang model.

Preferably, step S23 specifically comprises the following contents:

S231, inputting the precipitation data and the runoff data into the hydrological model, and obtaining a runoff forecast sequence {F1, F2, F3, . . . Fn} output by the hydrological model, where the runoff forecast sequence comprises the runoff volume in each time period;

S232, according to the runoff forecast sequence output by the hydrological model and in combination with the runoff data in the same time period, obtaining a data set {δj, Δqj+1} composed of the forecast error δj in the time period j and the runoff change volume Δqj+1 caused by the reservoir regulation and storage in the time period j+1; where jε(0,n];

S233, combining the data set in step S232 and setting the hyper-parameter in the KNN model as k=5 to obtain the regulation and storage influence quantity estimation model which is the relationship between the forecast error in the current time period and the runoff change volume caused by the reservoir regulation and storage in the next time period.

Preferably, step S3 specifically comprises selecting a date to be forecast, combining the precipitation data and the runoff data to drive the hydrological model and obtain the runoff volume of the date to be forecast, so as to realize the forecast of the future runoff volume.

Preferably, step S4 specifically comprises that a forecast time period is i+1, then the previous time period is i, and the forecast error in the time period i is obtained by subtracting the runoff forecast value in the time period i from the runoff data in the time period i and can be expressed as,

δᵢ=Qᵢ−Fᵢ

wherein δi is the forecast error in the time period i; Qi is the runoff data in the time period i; Fi is the runoff forecast value in the time period i.

Preferably, step S5 specifically comprises: inputting the forecast error in time period i into the regulation and storage influence quantity estimation model to obtain the distance ⊕δi−δj| between the forecast error in the time period i and the forecast error in each period j in the data set {δj, Δqj+1}, extracting runoff change volumes Δqj+1 corresponding to five forecast errors in time period j having the smallest distances, and calculating an average value of the five runoff change volumes Δqj+1 to obtain the estimated value Δqi+1 of the regulation and storage influence quantity in the time period i+1.

Preferably, step S6 is specifically calculated by the following formula:

F′ᵢ₊₁=Fᵢ₊₁+Δqᵢ₊₁

wherein, F′i+1 is the runoff forecast value in the future time period i+1; Fi+1 is the runoff volume in the time period i+1 output by the regulation and storage influence quantity estimation model; Δqi+1 is the estimated value of the regulation and storage influence quantity in the time period i+1.

The beneficial effects of the present invention are that: 1. in the method provided by the present invention, by utilizing the rule that reservoir group storage and discharge conditions can be indirectly reflected by the forecast error at the previous moment, a correlation between the forecast error and the change volume (influence volume) of the runoff due to the reservoir storage and discharge is established, and a forecast result of the regulation and storage influence quantity estimation model is corrected, thereby achieving the purpose of forecasting the runoff under the influence of the reservoir group without directly obtaining a storage and discharge plan of the upstream reservoir group. 2. by using the method of the present invention to carry out the runoff forecast under the influence of the upstream reservoir group, since the influence of the upstream reservoir group on the runoff is considered in the forecasting process, a higher accuracy than traditional hydrological forecasting methods is obtained. 3. by obtaining a scheduling plan of the upstream reservoir group in advance, the accuracy of the runoff forecast under the influence of the reservoir group can be significantly improved. This is the traditional method and means to carry out the runoff forecast under the influence of the upstream reservoir group. The application prerequisite of the traditional method is that the scheduling plan of the upstream reservoir group can be obtained, but such data is actually difficult to be obtained. Therefore, the application condition of the traditional method is more stringent. Compared with the traditional method, the method of the present invention is used to carry out the runoff forecast under the influence of the upstream reservoir group. Due to the correlation between the forecast error and the runoff of the reservoir group regulation and storage is established, it is no longer necessary to collect the scheduling plans of a large number of upstream reservoir groups, and the required data is easier to be obtained.

### BRIEF DESCRIPTION OF THE DRAWINGS

FIG. 1 is a schematic flowchart of a method in an embodiment of the present invention.

### DETAILED DESCRIPTION OF THE EMBODIMENTS

In order to make the purpose, technical solutions and advantages of the present invention clearer, the present invention will be further described in detail below with reference to the accompanying drawings. It should be understood that the specific implementations described herein are only used to explain the present invention, and not to limit the present invention.

### First Embodiment

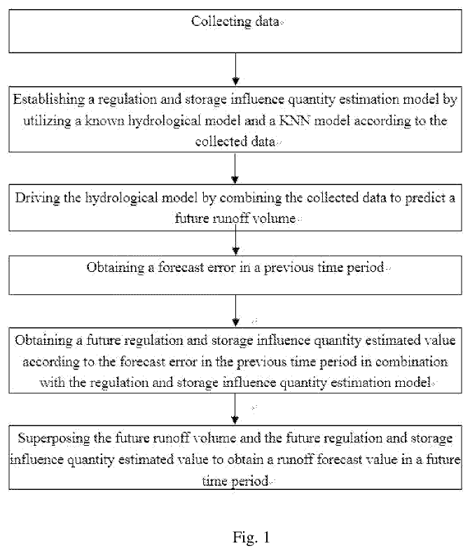

As shown in FIG. 1, provided in the present embodiment is a method for forecasting runoff under the influence of an upstream reservoir group by utilizing forecasting errors, wherein the method comprises the following steps:

S1, collecting data;

S2, establishing a regulation and storage influence quantity estimation model by utilizing a known hydrological model and a KNN model according to the collected data;

S3, driving the hydrological model by combining the collected data to predict a future

runoff volume;

S4, obtaining a forecast error in a previous time period;

S5, obtaining a future regulation and storage influence quantity estimated value according to the forecast error in the previous time period in combination with the regulation and storage influence quantity estimation model;

S6, superposing the future runoff volume and the future regulation and storage influence quantity estimated value to obtain a runoff forecast value in a future time period.

In this embodiment, the application prerequisite of the method provided by the present invention is that there is already a hydrological model that can forecast a forecast section; hydrological model parameters are calibrated by using the precipitation and runoff data in the time period when an upstream reservoir is not built or the influence of the reservoir is small; the main error of the runoff forecast of this section comes from the regulation and storage of the upstream reservoir. Under the condition that the above prerequisite is established, the present invention mainly comprises four steps: collecting the data; establishing the regulation and storage influence quantity estimation model to forecast the future runoff volume; obtaining the forecast error in the previous time period, and obtaining the future regulation and storage influence quantity estimated value; and, superposing a forecast value of the future runoff volume and the future regulation and storage influence quantity estimated value.

In this embodiment, the data collected in step Si specifically comprises precipitation data and runoff data, and the precipitation data is precipitation data during a time period from the time when the upstream reservoirs begin to significantly affect a downstream runoff process to the current time; the runoff data is precipitation data during a time period from the time when the upstream reservoirs begin to significantly affect the downstream runoff process to the current time. The specific data to be collected is as the following table.

| Sequence | | | | |
|---|---|---|---|---|
| number | Name | Start time | End time | Note |
| 1 | Precip- | The time when the | Current | Daily-scale |
| | itation | upstream reservoir | time | data |
| | data | begins to | | Unit: mm |
| | | significantly affect | | |
| | | the downstream | | |
| | | runoff process | | |
| 2 | Runoff | Same as the | Same as the | Daily-scale |
| | data | precipitation data | precipitation | data |
| | | | data | Unit: m³/s |

In the present embodiment, step S2 specifically comprises the following contents:

S21, taking a daily-scale forecast with a forecast period of 1 day as an example, according to the application prerequisite of the method in the present invention that a main source of the forecast errors is a natural runoff change caused by upstream reservoir regulation and storage. Therefore, the forecast error can be expressed as:

ω=δ+ϵ

wherein, ω is a total forecast error; δ is a forecast error caused by the upstream reservoir regulation and storage; ϵ is other forecast error; ω≈δ; (Unit: m3/s).

S22, because the forecast error is mainly caused by the upstream reservoir regulation and storage, and the amount of the error is a runoff change volume caused by the regulation and storage, and the reservoir regulation and storage is based on the state of the reservoir at the initial moment, comprising water storage, water level, etc. Therefore, the mechanism of runoff change caused by the reservoir regulation and storage can be generalized as

δᵢ'T(stateᵢ₋₁)

wherein statei−1 is a state of the reservoir at the initial moment, that is, a state of the reservoir at the end of the previous time period, and δi is a runoff forecast error at the current moment, that is, the runoff change volume caused by the reservoir regulation and storage; because the current state of the reservoir is the state at the previous moment plus regulation and storage quantity of the reservoir (contrary to the sign of impact on the runoff, and, if the reservoir increases the storage capacity, the runoff volume will decrease), the state of the reservoir at the current moment is calculated as

stateᵢ=stateᵢ₋₁−86400×δᵢ;

It can be seen from the formula for calculating the state of the reservoir at the current moment that since the state of the reservoir at the previous moment is known, the current state of the reservoir is linearly related to the current forecast error, and the current state of the reservoir has an impact on the runoff process in the next time period, and in turn determines the forecast error of the next time period, that is, the current forecast error is related to the runoff change caused by the reservoir regulation and storage in the next time period.

Based on the above conclusions, the known forecast error in the current time period can be used to forecast the runoff change volume caused by the reservoir regulation and storage in a future time period. In the present invention, the KNN model is selected as the known hydrological model to establish relationship between the forecast error in the current time period and the runoff change volume caused by the reservoir regulation and storage in the next time period. According to the mechanism of the KNN model, it is necessary to establish a data set {δi, Δqi+1} of the forecast error Si during the time period i and the runoff change volume Δqi+1 caused by the reservoir regulation and storage during the time period i+1; that is, the contents of step S23,

S23, establishing the regulation and storage influence quantity estimation model by utilizing the known hydrological model, where the regulation and storage influence quantity estimation model is a relationship between the forecast error in the current time period and the runoff change volume caused by the reservoir regulation and storage in the next time period. The known hydrological model is a Xinanjiang model.

In the present embodiment, step S23 specifically comprises the following contents:

S231, inputting the precipitation data and the runoff data into the KNN model, and obtaining a runoff forecast sequence {F1, F2, F3, . . . Fn} output by the KNN model, where the runoff forecast sequence comprises the runoff volume in each time period;

S232, according to the runoff simulation sequence, obtaining a data set {δj, Δqj+1} composed of the forecast error δj in the time period j and the runoff change volume Δqj+1 caused by the reservoir regulation and storage in the time period j+1; where jε(0,n];

S233, combining the data set in step S232 and setting the hyper-parameter in the KNN model as k=5 to obtain the regulation and storage influence quantity estimation model which is the relationship between the forecast error in the current time period and the runoff change volume caused by the reservoir regulation and storage in the next time period.

In summary, the main process of step S23 is:

1. Using the precipitation and other data to drive the hydrological model;

2. Obtaining runoff simulation (forecast) sequence {F1, F2, F3, . . . Fn};

3. Obtaining the data set {δj, Δqj+1} composed of the forecast error δj in the time period j and the runoff change volume Δqj+1 caused by the reservoir regulation and storage in the time period j+1; where jε(0,n].

In this embodiment, step S3 specifically comprises selecting a date to be forecast, combining the precipitation data and the runoff data to drive the hydrological model and obtain the runoff volume of the date to be forecast, so as to realize the forecast of the future runoff volume.

Step S3 is to complete the construction of the data set, and according to the operating mechanism of a KNN algorithm, set the hyper-parameter in the KNN as k=5, in the actual forecasting process, and drive the hydrological model according to the obtained precipitation and other data to achieve the runoff change volume caused by the reservoir regulation and storage at the next moment, that is to realize the prediction of the future runoff volume. Since the present invention is aimed at the daily-scale runoff forecast with the forecast period of 1 day, the forecast future runoff volume here is the runoff volume of “tomorrow” or “a second time period”, and the unit is m³/s.

In the present embodiment, step S4 specifically comprises that a forecast time period is i+1, then the previous time period is i, and the forecast error in the time period i is obtained by subtracting the runoff forecast value in the time period i from the runoff data in the time period i and can be expressed as,

δᵢ=Qᵢ−Fᵢ

wherein, δi is the forecast error in the time period i; Qi is the runoff data in the time period i; Fi is the runoff forecast value in the time period i.

In this embodiment, step S5 specifically comprises inputting the forecast error in the time period i into the regulation and storage influence quantity estimation model to obtain the distance |δi−δj| between the forecast error in time period i and the forecast error in each period j in the data set {δj, Δqj+1}, extracting runoff change volumes Δqj+1 corresponding to five forecast errors in time period j having the smallest distances, and calculating an average value of the five runoff change volumes Δqj+1 to obtain the estimated value Δqi+1 of the regulation and storage influence quantity in the time period i+1.

In the present embodiment, step S6 is specifically calculated by the following formula:

′ᵢ₊₁=Fᵢ₊₁+Δqᵢ₊₁

wherein, F′i+1 is the runoff forecast value in the future time period i+1, where the unit is m3/s; Fi+1 is the runoff volume in the time period i+1 output by the regulation and storage influence quantity estimation model, where the unit is m3/s; Δqi+1 is the estimated value of the regulation and storage influence quantity (estimation value) in the time period i+1, where the unit is m3/s.

### Second Embodiment

In this embodiment, the Danjiangkou Reservoir is selected as a research object, and a forecast effect verification time period is from Jul. 1, 2016 to Jul. 31, 2016. The forecast purpose is to obtain daily-scale runoff with a forecast period of 1 day, so as to explain in detail the implementation process of the method provided in the present invention.

1. Collecting data; the data to be collected is shown in the following table (due to too much data, only part of the data is shown):

| Sequence | | | | |
|---|---|---|---|---|
| number | Name | Start time | End time | Note |
| 1 | Precipitation data on the | Jan. 1, | Dec. 31, | Daily-scale |
| | basin above the | 2009 | 2016 | data |
| | Danjiangkou Reservoir | | | Unit: mm |
| 2 | Observed value of the | Jan. 1, | Dec. 31, | Daily-scale |
| | Danjiangkou Reservoir's | 2009 | 2016 | data |
| | incoming runoff | | | Unit: m³/s |

2. Establishing a regulation and storage influence quantity estimation model;

Since the selected forecast effect verification time is from Jul. 1, 2016 to Jul. 31, 2016, the precipitation data from Jan. 1, 2009 to Jun. 30, 2016 is selected to drive a hydrological model so as to obtain historical forecast information, and runoff data from Jan. 1, 2009 to Jun. 30, 2016 is combined to jointly establish the regulation and storage influence quantity estimation model. The specific steps of the embodiment are as follows:

(1). Using the precipitation and other data to drive the hydrological model

The hydrological model selected in this embodiment is a Xinanjiang model that has been applied in the Danjiangkou Reservoir. This model is calibrated by using the precipitation and runoff data before 2009, and the calibrated Nash efficiency coefficient reaches 0.97, while the number of reservoirs in the basin above the Danjiangkou reservoir before 2009 is relatively small, and the capacity for regulation and storage is limited. The impact on the Danjiangkou Reservoir's incoming is small, and it can be considered as a natural runoff process. Inputting daily-scale precipitation data from Jan. 1, 2009 to Jun. 30, 2016 into the Xinanjiang model to obtain daily-scale runoff forecast data Fi for the corresponding time period, and combining runoff observation data Qi at the same time period to calculate forecast error information Si and a runoff change volume Δqi+1 in the next time period, as described in the following table (due to too much data, only part of the data is shown).

| | | | | | Runoff change |
|---|---|---|---|---|---|
| | | | | | volume in the next |
| Name of | | Forecast flow | Observation | Forecast error | time period |
| section | Time | (Fᵢ) | flow (Qᵢ) | (δᵢ) | (Δ_{qi+1}) |
| Danjiangkou | 2009 Jan. 01 | 111123.0777079 | 181.7 | 58.62229207 | 47.29566185 |
| Reservoir | | | | | |
| Danjiangkou | 2009 Jan. 02 | 175.7043381 | 223 | 47.29566185 | 25.8481458 |
| Reservoir | | | | | |
| Danjiangkou | 2009 Jan. 03 | 273.6518542 | 299.5 | 25.8481458 | 54.37512492 |
| Reservoir | | | | | |
| Danjiangkou | 2009 Jan. 04 | 23.82487508 | 78.2 | 54.37512492 | 98.67271993 |
| Reservoir | | | | | |
| Danjiangkou | 2009 Jan. 05 | 88.02728007 | 186.7 | 98.67271993 | 16.30457587 |
| Reservoir | | | | | |
| Danjiangkou | 2009 Jan. 06 | 254.8954241 | 271.2 | 16.30457587 | 63.83854698 |
| Reservoir | | | | | |
| Danjiangkou | 2009 Jan. 07 | 155.761453 | 219.6 | 63.83854698 | 49.62285277 |
| Reservoir | | | | | |
| Danjiangkou | 2009 Jan. 08 | 132.0771472 | 181.7 | 49.62285277 | 58.4346443 |
| Reservoir | | | | | |
| Danjiangkou | 2009 Jan. 09 | 113.2653557 | 171.7 | 58.4346443 | 3.069544431 |
| Reservoir | | | | | |
| Danjiangkou | 2009 Jan. 10 | 279.9304556 | 283 | 3.069544431 | 7.091799227 |
| Reservoir | | | | | |
| Danjiangkou | 2009 Jan. 11 | 493.8082008 | 500.9 | 7.091799227 | 20.44039113 |
| Reservoir | | | | | |
| Danjiangkou | 2009 Jan. 12 | 327.0596089 | 347.5 | 20.44039113 | 54.40158202 |
| Reservoir | | | | | |
| Danjiangkou | 2009 Jan. 13 | 82.79841798 | 137.2 | 54.40158202 | 44.62681106 |
| Reservoir | | | | | |
| Danjiangkou | 2009 Jan. 14 | 314.8731889 | 359.5 | 44.62681106 | 4.099989171 |
| Reservoir | | | | | |
| Danjiangkou | 2009 Jan. 15 | 291.9000108 | 296 | 4.099989171 | 17.03707855 |
| Reservoir | | | | | |
| Danjiangkou | 2009 Jan. 16 | 214.6629214 | 231.7 | 17.03707855 | 40.1997396 |
| Reservoir | | | | | |
| Danjiangkou | 2009 Jan. 17 | 205.0002604 | 245.2 | 40.1997396 | 87.75925961 |
| Reservoir | | | | | |
| Danjiangkou | 2009 Jan. 18 | 227.6407404 | 315.4 | 87.75925961 | 84.73556607 |
| Reservoir | | | | | |
| Danjiangkou | 2009 Jan. 19 | 155.7644339 | 240.5 | 84.73556607 | 5.178010421 |
| Reservoir | | | | | |
| Danjiangkou | 2009 Jan. 20 | 164.3219896 | 169.5 | 5.178010421 | 41.96571361 |
| Reservoir | | | | | |
| Danjiangkou | 2009 Jan. 21 | 177.6342864 | 219.6 | 41.96571361 | 62.97239252 |
| Reservoir | | | | | |
| Danjiangkou | 2009 Jan. 22 | 253.3276075 | 316.3 | 62.97239252 | 95.41165186 |
| Reservoir | | | | | |
| Danjiangkou | 2009 Jan. 23 | 180.5883481 | 276 | 95.41165186 | −3.209453819 |
| Reservoir | | | | | |
| Danjiangkou | 2009 Jan. 24 | 47.70945382 | 44.5 | −3.209453819 | 58.47544721 |
| Reservoir | | | | | |
| Danjiangkou | 2009 Jan. 25 | 79.12455279 | 137.6 | 58.47544721 | 68.00298074 |
| Reservoir | | | | | |
| Danjiangkou | 2009 Jan. 26 | 97.59701926 | 165.6 | 68.00298074 | 54.09459314 |
| Reservoir | | | | | |
| Danjiangkou | 2009 Jan. 27 | 259.3054069 | 313.4 | 54.09459314 | 48.55912286 |
| Reservoir | | | | | |
| Danjiangkou | 2009 Jan. 28 | 21.14087714 | 69.7 | 48.55912286 | 8.034303694 |
| Reservoir | | | | | |
| Danjiangkou | 2009 Jan. 29 | 124.5656963 | 132.6 | 8.034303694 | 70.61414269 |
| Reservoir | | | | | |
| Danjiangkou | 2009 Jan. 30 | 118.8858573 | 189.5 | 70.61414269 | 6.650642739 |
| Reservoir | | | | | |
| Danjiangkou | 2009 Jan. 31 | 74.34935726 | 81 | 6.650642739 | 13.84122053 |
| Reservoir | | | | | |
| Danjiangkou | 2009 Feb. 01 | 215.1587795 | 229 | 13.84122053 | 44.71307024 |
| Reservoir | | | | | |
| Danjiangkou | 2009 Feb. 02 | 193.4869298 | 238.2 | 44.71307024 | 49.49702044 |
| Reservoir | | | | | |
| Danjiangkou | 2009 Feb. 03 | 47.30297956 | 96.8 | 49.49702044 | 43.93535425 |
| Reservoir | | | | | |
| Danjiangkou | 2009 Feb. 04 | 167.9646457 | 211.9 | 43.93535425 | 87.88278213 |
| Reservoir | | | | | |
| Danjiangkou | 2009 Feb. 05 | 43.81721787 | 131.7 | 87.88278213 | 38.27761981 |
| Reservoir | | | | | |
| Danjiangkou | 2009 Feb. 06 | 75.82238019 | 114.1 | 38.27761981 | 16.56322489 |
| Reservoir | | | | | |
| Danjiangkou | 2009 Feb. 07 | 33.73677511 | 50.3 | 16.56322489 | 87.74816631 |
| Reservoir | | | | | |
| Danjiangkou | 2009 Feb. 08 | 292.1518337 | 379.9 | 87.74816631 | 52.04161576 |
| Reservoir | | | | | |
| Danjiangkou | 2009 Feb. 09 | 117.8583842 | 169.9 | 52.04161576 | 74.06944068 |
| Reservoir | | | | | |
| Danjiangkou | 2009 Feb. 10 | 25.93055932 | 100 | 74.06944068 | 83.46678791 |
| Reservoir | | | | | |
| Danjiangkou | 2009 Feb. 11 | 221.8332121 | 305.3 | 83.46678791 | 84.69085863 |
| Reservoir | | | | | |
| Danjiangkou | 2009 Feb. 12 | 158.6091414 | 243.3 | 84.69085863 | 95.34622436 |
| Reservoir | | | | | |
| Danjiangkou | 2009 Feb. 13 | 142.9537756 | 238.3 | 95.34622436 | 79.8083079 |
| Reservoir | | | | | |
| Danjiangkou | 2009 Feb. 14 | 231.6916921 | 311.5 | 79.8083079 | 63.67818426 |
| Reservoir | | | | | |
| Danjiangkou | 2009 Feb. 15 | 207.8218157 | 271.5 | 63.67818426 | 69.12446136 |
| Reservoir | | | | | |
| Danjiangkou | 2009 Feb. 16 | 61.97553864 | 131.1 | 69.12446136 | 92.6873793 |
| Reservoir | | | | | |
| Danjiangkou | 2009 Feb. 17 | 231.2126207 | 323.9 | 92.6873793 | 4.104256306 |
| Reservoir | | | | | |
| Danjiangkou | 2009 Feb. 18 | 436.6957437 | 440.8 | 4.104256306 | 42.85121903 |
| Reservoir | | | | | |
| Danjiangkou | 2009 Feb. 19 | 340.948781 | 383.8 | 42.85121903 | 52.66282706 |
| Reservoir | | | | | |
| Danjiangkou | 2009 Feb. 20 | 360.3371729 | 413 | 52.66282706 | 33.04819764 |
| Reservoir | | | | | |
| Danjiangkou | 2009 Feb. 21 | 166.3518024 | 199.4 | 33.04819764 | 65.59019532 |
| Reservoir | | | | | |
| Danjiangkou | 2009 Feb. 22 | 237.4098047 | 303 | 65.59019532 | 16.68211297 |
| Reservoir | | | | | |
| Danjiangkou | 2009 Feb. 23 | 359.217887 | 375.9 | 16.68211297 | 2.579859426 |
| Reservoir | | | | | |
| Danjiangkou | 2009 Feb. 24 | 333.3201406 | 335.9 | 2.579859426 | 85.27168255 |
| Reservoir | | | | | |
| Danjiangkou | 2009 Feb. 25 | 592.6283175 | 677.9 | 85.27168255 | 92.34843923 |
| Reservoir | | | | | |
| Danjiangkou | 2009 Feb. 26 | 715.2515608 | 807.6 | 92.34843923 | |
| Reservoir | | | | | |
| . . . | . . . | . . . | . . . | . . . | . . . |

(2). Obtaining runoff simulation (forecast) sequence {F1, F2, F3, . . . Fn};

The “Forecast Flow (Fi)” listed in the above table is the obtained runoff simulation (forecast) sequence.

(3). Obtaining a data set {δj, Δqj+1} composed of the forecast error δj in the time period j and the runoff change volume Δqj+1 caused by the reservoir regulation and storage in the time period j+1; where jε(0,n];

The combination of column “prediction error (δj)” and column “runoff change volume (Δqj+1) in the next time period” in the above table is the “data set {δj, Δqj+1}”.

After the construction of the above data set is completed, according to the operating mechanism of a KNN algorithm, a hyper-parameter in a KNN model is set as k=5, and the establishment of the regulation and storage influence quantity estimation model is completed.

3. Forecasting future runoff volumes

The forecast verification time period selected in this embodiment is from Jul. 2, 2016 to Jul. 31, 2016, where the runoff volumes include a total of 30 days of daily runoff forecast values. Since the Xinanjiang model used in this embodiment can only forecast the runoff volume in the next day, in order to better illustrate the effectiveness of the present invention, the daily accumulated precipitation from Jun. 1, 2016 to Jun. 30, 2016 is used to drive a hydrological model for preheating. Based on the preheating, using 31 pieces of precipitation data from Jul. 1, 2016 to Jul. 31, 2016 to drive the hydrological model, run 31 times, and obtain 31 forecast results, which are listed in the table below.

| | Measured | Forecast runoff with |
|---|---|---|
| Date | runoff | Xinanjiang model |
| 2016 Jul. 01 | 773 | 981.4777906 |
| 2016 Jul. 02 | 810 | 968.5364213 |
| 2016 Jul. 03 | 711 | 832.0640394 |
| 2016 Jul. 04 | 423 | 807.8978364 |
| 2016 Jul. 05 | 409 | 615.3510802 |
| 2016 Jul. 06 | 138 | 469.969122 |
| 2016 Jul. 07 | 619 | 1117.658142 |
| 2016 Jul. 08 | 757 | 1043.039863 |
| 2016 Jul. 09 | 466 | 519.5576857 |
| 2016 Jul. 10 | 327 | 513.8985641 |
| 2016 Jul. 11 | 564 | 834.2230372 |
| 2016 Jul. 12 | 592 | 1042.741363 |
| 2016 Jul. 13 | 581 | 637.7200687 |
| 2016 Jul. 14 | 1480 | 1498.464158 |
| 2016 Jul. 15 | 1640 | 1943.726127 |
| 2016 Jul. 16 | 1780 | 2242.721982 |
| 2016 Jul. 17 | 1320 | 1722.908443 |
| 2016 Jul. 18 | 1040 | 1382.139659 |
| 2016 Jul. 19 | 1410 | 1706.848477 |
| 2016 Jul. 20 | 2340 | 2721.277143 |
| 2016 Jul. 21 | 1540 | 1702.29011 |
| 2016 Jul. 22 | 1090 | 1504.468346 |
| 2016 Jul. 23 | 336 | 469.0391414 |
| 2016 Jul. 24 | 911 | 1128.836117 |
| 2016 Jul. 25 | 474 | 672.294591 |
| 2016 Jul. 26 | 898 | 936.365495 |
| 2016 Jul. 27 | 586 | 669.6127829 |
| 2016 Jul. 28 | 1430 | 1846.677136 |
| 2016 Jul. 29 | 1160 | 1383.445582 |
| 2016 Jul. 30 | 1180 | 1518.267742 |
| 2016 Jul. 31 | 1080 | 1451.723783 |

4. Obtaining a forecast error in the previous time period

The forecast error is obtained by subtracting the forecast runoff with the Xinanjiang model from the measured runoff in the above table (relative to the forecast time period, the forecast error is the forecast error in the previous time period), as shown in the last column of the following table.

| | Measured | Forecast runoff with | Forecast |
|---|---|---|---|
| Date | runoff | Xinanjiang model | error |
| 2016 Jul. 01 | 773 | 981.4777906 | −208.4777906 |
| 2016 Jul. 02 | 810 | 968.5364213 | −158.5364213 |
| 2016 Jul. 03 | 711 | 832.0640394 | −121.0640394 |
| 2016 Jul. 04 | 423 | 807.8978364 | −384.8978364 |
| 2016 Jul. 05 | 409 | 615.3510802 | −206.3510802 |
| 2016 Jul. 06 | 138 | 469.969122 | −331.969122 |
| 2016 Jul. 07 | 619 | 1117.658142 | −498.6581421 |
| 2016 Jul. 08 | 757 | 1043.039863 | −286.0398629 |
| 2016 Jul. 09 | 466 | 519.5576857 | −53.55768565 |
| 2016 Jul. 10 | 327 | 513.8985641 | −186.8985641 |
| 2016 Jul. 11 | 564 | 834.2230372 | −270.2230372 |
| 2016 Jul. 12 | 592 | 1042.741363 | −450.7413634 |
| 2016 Jul. 13 | 581 | 637.7200687 | −56.72006866 |
| 2016 Jul. 14 | 1480 | 1498.464158 | −18.46415784 |
| 2016 Jul. 15 | 1640 | 1943.726127 | −303.7261268 |
| 2016 Jul. 16 | 1780 | 2242.721982 | −462.7219825 |
| 2016 Jul. 17 | 1320 | 1722.908443 | −402.9084426 |
| 2016 Jul. 18 | 1040 | 1382.139659 | −342.1396595 |
| 2016 Jul. 19 | 1410 | 1706.848477 | −296.8484772 |
| 2016 Jul. 20 | 2340 | 2721.277143 | −381.2771434 |
| 2016 Jul. 21 | 1540 | 1702.29011 | −162.2901097 |
| 2016 Jul. 22 | 1090 | 1504.468346 | −414.4683456 |
| 2016 Jul. 23 | 336 | 469.0391414 | −133.0391414 |
| 2016 Jul. 24 | 911 | 1128.836117 | −217.8361174 |
| 2016 Jul. 25 | 474 | 672.294591 | −198.294591 |
| 2016 Jul. 26 | 898 | 936.365495 | −38.36549498 |
| 2016 Jul. 27 | 586 | 669.6127829 | −83.61278287 |
| 2016 Jul. 28 | 1430 | 1846.677136 | −416.677136 |
| 2016 Jul. 29 | 1160 | 1383.445582 | −223.4455816 |
| 2016 Jul. 30 | 1180 | 1518.267742 | −338.2677419 |
| 2016 Jul. 31 | 1080 | 1451.723783 | −371.7237834 |

As can be seen from the above table, the upstream reservoirs intercepted runoff to varying degrees in July, which resulted in the generally higher forecast results of the Xinanjiang model.

5. Obtaining the estimated values of the future regulation and storage influence quantity.

According to the method introduced in the first embodiment, the estimated values of the regulation and storage influence in the forecast time period (the estimated values of the future regulation and storage influence quantity) are obtained, as shown in the last column of the following table:

| | | | | Estimated |
|---|---|---|---|---|
| | | | | value of |
| | | | | the future |
| | | Forecast | | regulation |
| | | runoff | | and |
| | | with | | storage |
| | Measured | Xinanjiang | Forecast | influence |
| Date | runoff | model | error | quantity |
| 2016 Jul. 01 | 773 | 981.4777906 | −208.4777906 | |
| 2016 Jul. 02 | 810 | 968.5364213 | −158.5364213 | −137.572579 |
| 2016 Jul. 03 | 711 | 832.0640394 | −121.0640394 | −104.8745406 |
| 2016 Jul. 04 | 423 | 807.8978364 | −384.8978364 | −355.8711378 |
| 2016 Jul. 05 | 409 | 615.3510802 | −206.3510802 | −149.9599759 |
| 2016 Jul. 06 | 138 | 469.969122 | −331.969122 | −156.6991408 |
| 2016 Jul. 07 | 619 | 1117.658142 | −498.6581421 | −232.0724935 |
| 2016 Jul. 08 | 757 | 1043.039863 | −286.0398629 | −222.6857634 |
| 2016 Jul. 09 | 466 | 519.5576857 | −53.55768565 | −50.95472822 |
| 2016 Jul. 10 | 327 | 513.8985641 | −186.8985641 | −34.91305245 |
| 2016 Jul. 11 | 564 | 834.2230372 | −270.2230372 | −160.6209183 |
| 2016 Jul. 12 | 592 | 1042.741363 | −450.7413634 | −62.05214966 |
| 2016 Jul. 13 | 581 | 637.7200687 | −56.72006866 | −31.77375448 |
| 2016 Jul. 14 | 1480 | 1498.464158 | 46415784 | −18.6329034 |
| 2016 Jul. 15 | 1640 | 1943.726127 | −303.7261268 | −124.0817908 |
| 2016 Jul. 16 | 1780 | 2242.721982 | −462.7219825 | −17.71318935 |
| 2016 Jul. 17 | 1320 | 1722.908443 | −402.9084426 | −10.29585157 |
| 2016 Jul. 18 | 1040 | 1382.139659 | −342.1396595 | −26.41614625 |
| 2016 Jul. 19 | 1410 | 1706.848477 | −296.8484772 | −100.3125198 |
| 2016 Jul. 20 | 2340 | 2721.277143 | −381.2771434 | −455.4021723 |
| 2016 Jul. 21 | 1540 | 1702.29011 | −162.2901097 | −100.5748648 |
| 2016 Jul. 22 | 1090 | 1504.468346 | −414.4683456 | −370.7669409 |
| 2016 Jul. 23 | 336 | 469.0391414 | −133.0391414 | −16.23080435 |
| 2016 Jul. 24 | 911 | 1128.836117 | −217.8361174 | −149.1279152 |
| 2016 Jul. 25 | 474 | 672.294591 | −198.294591 | −191.6265372 |
| 2016 Jul. 26 | 898 | 936.365495 | −38.36549498 | −35.92955197 |
| 2016 Jul. 27 | 586 | 669.6127829 | −83.61278287 | −49.33584972 |
| 2016 Jul. 28 | 1430 | 1846.677136 | −416.677136 | −494.268071 |
| 2016 Jul. 29 | 1160 | 1383.445582 | −223.4455816 | −173.2191907 |
| 2016 Jul. 30 | 1180 | 1518.267742 | −338.2677419 | −175.5355712 |
| 2016 Jul. 31 | 1080 | 1451.723783 | −371.7237834 | −212.5367952 |

6. Superimposing the forecast value of the future runoff volume and the estimated value of the regulation and storage influence quantity

After superimposing the forecast value of the future runoff volume and the estimated value of the regulation and storage influence quantity, a final forecast result is obtained, as shown in the last column of the following table:

| | | Forecast | | | Forecast |
|---|---|---|---|---|---|
| | | runoff | | Runoff | runoff |
| | | with | | change | in the |
| | Measured | Xinanjiang | Forecast | volume | present |
| Date | runoff | model | error | (Estimated) | invention |
| 2016 Jul. 01 | 773 | 981.4777906 | −208.4777906 | | |
| 2016 Jul. 02 | 810 | 968.5364213 | −158.5364213 | −137.572579 | 830.9638423 |
| 2016 Jul. 03 | 711 | 832.0640394 | −121.0640394 | −104.8745406 | 727.1894988 |
| 2016 Jul. 04 | 423 | 807.8978364 | −384.8978364 | −355.8711378 | 452.0266986 |
| 2016 Jul. 05 | 409 | 615.3510802 | −206.3510802 | −149.9599759 | 465.3911043 |
| 2016 Jul. 06 | 138 | 469.969122 | −331.969122 | −156.6991408 | 313.2699812 |
| 2016 Jul. 07 | 619 | 1117.658142 | −498.6581421 | −232.0724935 | 885.5856486 |
| 2016 Jul. 08 | 757 | 1043.039863 | −286.0398629 | −222.6857634 | 820.3540995 |
| 2016 Jul. 09 | 466 | 519.5576857 | −53.55768565 | −50.95472822 | 468.6029574 |
| 2016 Jul. 10 | 327 | 513.8985641 | −186.8985641 | −34.91305245 | 478.9855116 |
| 2016 Jul. 11 | 564 | 834.2230372 | −270.2230372 | −160.6209183 | 673.6021189 |
| 2016 Jul. 12 | 592 | 1042.741363 | −450.7413634 | −62.05214966 | 980.6892137 |
| 2016 Jul. 13 | 581 | 637.7200687 | −56.72006866 | −31.77375448 | 605.9463142 |
| 2016 Jul. 14 | 1480 | 1498.464158 | −18.46415784 | −18.6329034 | 1479.831254 |
| 2016 Jul. 15 | 1640 | 1943.726127 | −303.7261268 | −124.0817908 | 1819.644336 |
| 2016 Jul. 16 | 1780 | 2242.721982 | −462.7219825 | −17.71318935 | 2225.008793 |
| 2016 Jul. 17 | 1320 | 1722.908443 | −402.9084426 | −10.29585157 | 1712.612591 |
| 2016 Jul. 18 | 1040 | 1382.139659 | −342.1396595 | −26.41614625 | 1355.723513 |
| 2016 Jul. 19 | 1410 | 1706.848477 | −296.8484772 | −100.3125198 | 1606.535957 |
| 2016 Jul. 20 | 2340 | 2721.277143 | −381.2771434 | −455.4021723 | 2265.874971 |
| 2016 Jul. 21 | 1540 | 1702.29011 | −162.2901097 | −100.5748648 | 1601.715245 |
| 2016 Jul. 22 | 1090 | 1504.468346 | −414.4683456 | −370.7669409 | 1133.701405 |
| 2016 Jul. 23 | 336 | 469.0391414 | −133.0391414 | −16.23080435 | 452.808337 |
| 2016 Jul. 24 | 911 | 1128.836117 | −217.8361174 | −149.1279152 | 979.7082022 |
| 2016 Jul. 25 | 474 | 672.294591 | −198.294591 | −191.6265372 | 480.6680538 |
| 2016 Jul. 26 | 898 | 936.365495 | −38.36549498 | −35.92955197 | 900.435943 |
| 2016 Jul. 27 | 586 | 669.6127829 | −83.61278287 | −49.33584972 | 620.2769331 |
| 2016 Jul. 28 | 1430 | 1846.677136 | −416.677136 | −494.268071 | 1352.409065 |
| 2016 Jul. 29 | 1160 | 1383.445582 | −223.4455816 | −173.2191907 | 1210.226391 |
| 2016 Jul. 30 | 1180 | 1518.267742 | −338.2677419 | −175.5355712 | 1342.732171 |
| 2016 Jul. 31 | 1080 | 1451.723783 | −371.7237834 | −212.5367952 | 1239.186988 |

A Nash efficiency coefficient is used to quantitatively evaluate the accuracy of the runoff forecast in the present invention and the Xinanjiang model. It can be seen that the Nash efficiency coefficient NS=0.88 of the runoff forecast in the present invention is higher than the Nash efficiency coefficient NS=0.66 directly forecasted by the Xinanjiang model. Moreover, the present invention increases the forecast accuracy from 0.66 to 0.88 without using the upstream reservoir group scheduling plan, which has less data requirements than traditional methods. The calculation formula of the Nash efficiency coefficient is as follows:

$$E = 1 - \frac{{\sum }_{i = 1}^{T} {( {Q}_{o}^{t} - {Q}_{m}^{t} )}^{2}}{{\sum }_{i = 1}^{T} {( {Q}_{o}^{t} - \overline{{Q}_{o}} )}^{2}}$$

Among them, Qo refers to an observed value, Qm refers to a simulated value, Qt (superscript) refers to a certain value at time t, and Qo (upper horizontal line) refers to a total average of the observed values. E is the Nash efficiency coefficient, and the value thereof is from negative infinity to 1. If E close to 1, indicating that the model is of good quality and high model credibility. If E close to 0, indicating that the simulation result is close to the average level of the observed values, that is, the overall result is credible, but the process simulation error is large. If E is much smaller than 0, the model is not credible.

By adopting the above-mentioned technical solutions disclosed by the present invention, the following beneficial effects are obtained:

Provided in the present invention is a method for forecasting runoff under the influence of an upstream reservoir group by utilizing forecasting errors. In the method, by utilizing the rule that reservoir group storage and discharge conditions can be indirectly reflected by the forecast error at the previous moment, a correlation between the forecast error and the change amount (influence volume) of the runoff due to the reservoir storage and discharge is established, and a forecast result of the regulation and storage influence quantity estimation model is corrected, thereby achieving the purpose of forecasting the runoff under the influence of the reservoir group without directly obtaining a storage and discharge plan of the upstream reservoir group. The method of the present invention is used to carry out the runoff forecast under the influence of the upstream reservoir group. Since the influence of the upstream reservoir group on the runoff is considered in the forecasting process, a higher accuracy than the traditional hydrological forecasting methods is obtained. By obtaining the scheduling plan of the upstream reservoir group in advance, the accuracy of the runoff forecast under the influence of the reservoir group can be significantly improved. This is the traditional method and means to carry out the runoff forecast under the influence of the upstream reservoir group. The application prerequisite of the traditional method is that the scheduling plan of the upstream reservoir group can be obtained, but such data is actually difficult to be obtained. Therefore, the application condition of the traditional method is more stringent. Compared with the traditional method, the method of the present invention is used to carry out the runoff forecast under the influence of the upstream reservoir group. Due to the correlation between the forecast error and the runoff of the reservoir group regulation and storage is established, it is no longer necessary to collect the scheduling plans of a large number of upstream reservoir groups, and the required data is easier to be obtained.

The above are only the preferred implementations of the present invention. It should be pointed out that for those of ordinary skill in the art, without departing from the principle of the present invention, several improvements and modifications can be made, and these improvements and modifications are also considered as in the protection scope of the present invention.

1. A method for forecasting runoff under influence of an upstream reservoir group by utilizing forecasting errors, wherein the method comprises the following steps:
S1, collecting data;
S2, establishing a regulation and storage influence quantity estimation model by utilizing a known hydrological model and a KNN model according to the collected data;
S3, driving the hydrological model by combining the collected data to predict a future runoff volume;
S4, obtaining a forecast error in a previous time period;
S5, obtaining a future regulation and storage influence quantity estimated value according to the forecast error in the previous time period in combination with the regulation and storage influence quantity estimation model;
S6, superposing the future runoff volume and the future regulation and storage influence quantity estimated value to obtain a runoff forecast value in a future time period.

2. The method for forecasting runoff under influence of an upstream reservoir group by utilizing forecasting errors according to claim 1, wherein the data collected in step S1 specifically comprises precipitation data and runoff data, and the precipitation data is precipitation data during a time period from the time when the upstream reservoirs begin to significantly affect a downstream runoff process to the current time; the runoff data is precipitation data during a time period from the time when the upstream reservoirs begin to significantly affect the downstream runoff process to the current time.

3. The method for forecasting runoff under influence of an upstream reservoir group by utilizing forecasting errors according to claim 2, wherein step S2 specifically comprises the following contents:
S21, based on a premise that a main source of the forecast errors is a natural runoff change caused by upstream reservoir regulation and storage, obtaining a forecast error calculation formula,
ω=δ+ϵ
wherein ω is a total forecast error; δ is a forecast error caused by the upstream reservoir regulation and storage; ϵ is other forecast error; ω≈δ;
S22, generalizing a mechanism of the runoff change caused by the reservoir regulation and storage as
δᵢ=T(stateᵢ₋₁)
wherein stateᵢ₋₁ is a state of the reservoir at the initial moment, that is, a state of the reservoir at the end of the previous time period, and δᵢ is a runoff forecast error at the current moment,
that is, a runoff change volume caused by the reservoir regulation and storage; then the reservoir state at the current moment is calculated as
stateᵢ=stateᵢ₋₁−86400×δᵢ;
S23, establishing the regulation and storage influence quantity estimation model by utilizing the known hydrological model and the KNN model, where the regulation and storage influence quantity estimation model is a relationship between the forecast error in the current time period and the runoff change volume caused by the reservoir regulation and storage in the next time period.

4. The method for forecasting runoff under influence of an upstream reservoir group by utilizing forecasting errors according to claim 3, wherein the known hydrological model is a Xinanjiang model.

5. The method for forecasting runoff under influence of an upstream reservoir group by utilizing forecasting errors according to claim 3, wherein step S23 specifically comprises the following contents:
S231, inputting the precipitation data and the runoff data into the hydrological model, and obtaining a runoff forecast sequence {F1, F2, F₃, . . . Fₙ,} output by the hydrological model, where the runoff forecast sequence comprises the runoff volume in each time period;
S232, according to the runoff forecast sequence output by the hydrological model and in combination with the runoff data in the same time period, obtaining a data set {δⱼ, Δqⱼ₊₁} composed of the forecast error δⱼ in the time period j and the runoff change volume Δq₁₊₁ caused by the reservoir regulation and storage in the time period j+1; where jε(0,n];
S233, combining the data set in step S232 and setting the hyper-parameter in the KNN model as k=5 to obtain the regulation and storage influence quantity estimation model which is the relationship between the forecast error in the current time period and the runoff change volume caused by the reservoir regulation and storage in the next time period.

6. The method for forecasting runoff under influence of an upstream reservoir group by utilizing forecasting errors according to claim 5, wherein step S3 specifically comprises selecting a date to be forecast, combining the precipitation data and the runoff data to drive the hydrological model and obtain the runoff volume of the date to be forecast, so as to realize the forecast of the future runoff volume.

7. The method for forecasting runoff under influence of an upstream reservoir group by utilizing forecasting errors according to claim 6, wherein step S4 specifically comprises that a forecast time period is i+1, then the previous time period is i, and the forecast error in the time period i is obtained by subtracting the runoff forecast value in the time period i from the runoff data in the time period i and can be expressed as,
δᵢ=Qᵢ−Fᵢ
wherein δᵢ is the forecast error in the time period i; Qᵢ is the runoff data in the time period i; Fᵢ is the runoff forecast value in the time period i.

8. The method for forecasting runoff under influence of an upstream reservoir group by utilizing forecasting errors according to claim 7, wherein, step S5 specifically comprises: inputting the forecast error in time period i into the regulation and storage influence quantity estimation model to obtain the distance |δᵢ−δⱼ| between the forecast error in the time period i and the forecast error in each period j in the data set {δⱼ, Δqⱼ₊₁}, extracting runoff change volumes Δqⱼ₊₁ corresponding to five forecast errors in time period j having the smallest distances, and calculating an average value of the five runoff change volumes Δqⱼ₊₁ to obtain the estimated value Δqⱼ₊₁ of the regulation and storage influence quantity in the time period i+1.

9. The method for forecasting runoff under influence of an upstream reservoir group by utilizing forecasting errors according to claim 8, wherein step S6 is specifically calculated by the following formula:
F′ᵢ₊₁=Fᵢ₊₁+Δ_{qi+1}
wherein, F′ᵢ₊₁ is the runoff forecast value in the future time period i+1; Fᵢ₊₁ is the runoff volume in the time period i+1 output by the regulation and storage influence quantity estimation model; Δ_{qi+1} is the estimated value of the regulation and storage influence quantity in the time period i+1.
